(19) United States
(12) Patent Application Publication
(10) Pub. No.: US 2021/0221340 A1
(43) Pub. Date: Jul. 22, 2021

(54) Multi components to prevent vehicles from accidents

(71) Applicant: P. Annadurai, Perambalur (IN)

(72) Inventor: P. Annadurai, Perambalur (IN)

(21) Appl. No.: 17/268,672

(22) PCT Filed: Jul. 25, 2019
(86) PCT No.: PCT/IN2019/000024

§ 371 Date: Feb. 16, 2021

(30) Foreign Application Priority Data
Aug. 16, 2018 (IN) 201841005948

(51) Int. Cl. B60T 7/22; B60T 3/00; B60R 19/02

(52) U.S. Cl. CPC B60T 7/22; B60R 19/023; B60T 3/00

(57) ABSTRACT

The present invention relates to reducing the bulk human fatalities and damage of vehicles during accidents. Usually, the motor vehicles during the collision all inertia forces and kinetic energy are absorbed by vehicles transmitted to road through all tyres. In this proposal, some part of the kinetic energy is utilized to change the shape and size of the newly designed components that is incorporated inside the vehicle and remaining kinetic energy is transmitted to road. Using Newton's third law, damage of vehicle can be greatly reduced by utilizing the elastic tension force and compressive force of the vehicle. It has to be attached in each vehicle and both side on road with same altitude from the ground clearance, during the accident another component external braking system activated by pneumatic controlling system without rotating the wheels and contact & non-contact sensor control suddenly stops the engine of the vehicle, steering mechanism can be controlled even at abnormal driving of driver. This device is designed to reduce the damage during the accidents by altering the cross sectional area of shapes like round/oval/polygon/irregular and size (length, area) of the vehicle.

### FIELD OF THE INVENTION

### 1) Automobiles, Trains and Ships, Submarine and Aero Space Vehicles

This invention relates to a system and a method for operating a motor vehicle, such as an automobile, Trains, Ships, Submarines, All types of flights, Rocket propulsion, future flying vehicles and for only landing without fuel and tire from any height of future free fall flights, wherein a controller or computerized system in future. Infrared (IR) Passive Infrared (PIR) sensors used is employed to assist and supplement the driver in the movement of the vehicle along a path of travel, such as a street or roadway and may be used in future cyclist and two wheeler motorcycles and 3 wheeler auto, finally individual human to avoid from accidents.

### 2) Design of Machine Components

The motor vehicles during the collision all kinetic energy is absorbed by chassis then transmit the load to road by all tires. FIG. 1 shows that the “C” channel is the main of all side of chassis, it is fixed component. FIG. 2 shows the “U” shape channels are the movable component with guide solid roller of the FIG. 1a. Interconnected with FIG. 1 and FIG. 2. It is an important component of FIG. 3a, 3b, 3c. If high elastic tension FIG. 4 shows the connects with high spring tension, linked in FIG. 5a, 5b, 5c is external braking system. It is hold by aircraft landing gear mechanism.

FIG. 5 shows the future advanced external braking system. FIG. 7 is used for without upset and fall of vehicles by suddenly stopped the rotating wheels. FIG. 8 function is to parallel to the FIG. 7. FIG. 9 is functioned only heavy vehicles, bus with passengers falling at the time of avoiding from upset. FIG. 10 shows the absorbing kinetic energy, inertia force and vibration, which is fixed in bottom leaf spring. FIG. 11 shows the acrylic sheet weightless and without broken.

FIG. 12 uses only for two wheeler motor cycle. FIG. 13 for main role of inter connected with FIG. 1, FIG. 2 and both side of the roads. The Individual human avoid from vehicles collide for FIG. 14 shows the scope of future work, FIG. 15 shows assembling of all component drawing.

### 3) Road Safety

Following the transportation rules and regulation.
Don't drink and drive the motor vehicles. Maybe drunken mood not possible create the vehicles accidents.
Develop the multidisciplinary road safety.
Support the creation of safety advocacy groups.
Proper roads maintenance

### BACKGROUND OF THE INVENTION

### Cross-Reference to Related Applications

This title informed/registered that in my country President of India on Dec. 14, 2004 at Rashtrapati Bahavan New Delhi and application is a continuation of Patent office Ser. No. 2386/CHE/2009, filed Sep. 30, 2009, and Application Ser. No. 3156/CHE/2009, filed Dec. 22, 2009, and Ref. No. E-6/81/2010/CHE, and Application Ser. No./201641006517/Ref No. E-2/597/2016-CHE filed Feb. 25, 2016, and Ref. E-6/146/2017-CHE, filed Aug. 16, 2017. Application Ser. No./201841005948, filed Feb. 16, 2018, and No./201841005948, filed Feb. 14, 2019

A major cause of human suffering is an automobile accident. Approximately 35.2% fatalities are died by road accidents from total deaths. By traffic accidents every year Worldwide, millions of peoples are being got major and minor injury. Due to the accidents and injuries the insurance company spends a huge amount of money for medical allowance and insurance amount (life/non-life) from the total amounts. According to the World National Highway Traffic Safety Administration, stated the crash damage, medical bills and life & non-life motor Insurance total is up to 8% to 12% approximate in printable money.

Automobile designers offer many safety features, including passenger restraints, improved braking systems, and body designs, intended to better protect automobile crash victims. But very little has been done in the area of automatic vehicle control systems based on modern electronics, computer systems, and advanced real-time software. This is true despite rapidly increasing capabilities in these technologies and pervasive application in many other areas including, for example the business, entertainment, logistics, Goods carriers, and medical fields. Vehicle guidance and control technology have, of course, been applied with great success in military defense systems, Avionics systems and space exploration systems. But, this technology is very cheap and affordable cost for poor people; it has not been commercialized yet.

The opportunity exists today to develop very low cost effective, commercial automated vehicle control systems. New advances in low-cost hardware and software technology make implementation feasible new improved Passive Infrared (PIR) sensors, contact and non-contact sensors systems for sensing between at a collision time only activating by the pneumatic control system. Motor vehicles make it very quick in time, use the excellent external braking system, and can be achieved indeed, to pursue new approaches.

Work on these problems has begun. Intelligent vehicle/highway systems are being investigated with traffic control systems intended to minimize congestion. Vehicles between uncontrolled or driver fault or any cause make the accidents. During this action, sensors detect the problem and resolved this has been applied to external braking systems in subway and train systems.

While these developments are important, they fail to protect vehicles from many types of collisions or minimize the damage from there. More particularly, such systems fail to exercise simultaneous, coordinated control over vehicle steering and speed, fail to take full advantage of identification of different condition or hazard types using standard stored models of production vehicles and other commonly encountered roadway pedestrian, fail to deal effectively with pedestrian and hazards located simultaneously on different sides of the vehicle, and fail to capitalize fully on modern expert system decision and control technology, such as represented by sensors and time delaying methods, to deal with more complex and hazardous situations

### Objective of Invention

FIG. 1 shows the position at rest when the vehicle with absorption the vibration. In the FIG. 1 is fixed at all vehicles with same height from ground clearance. FIG. 2 is inserted FIG. 1. During the accident, a slight dashing happened and again comes to normal stage. In which the component of FIG. 3a, 3b, 3c works out as Newton's third law. As the FIG. 1 and FIG. 2 are multi connections with continuous link by FIG. 3a, 3b, 3c.

During the process dashing FIG. 4 shows the releasing of Elastic Tension force from the pneumatic component with high tension cut by FIG. 2a within the millisecond. FIG. 5^{th} serials and FIG. 6 show to stop rotating the wheels immediately at the same time. This process in every vehicle first that-function is to arrest a rear wheels and front wheels moving in the same direction within few millisecond that arrest the both side of all back wheels.

Finally setting the Pneumatic controlling system our requirement millisecond delay function in front wheel function in FIG. 5^{th} serial is the important role of the excellent external breaking system, throughout the world entire tires manufacture co-operate and the ground touched the face tires button without any (zig-zag) design planning, but only square/rectangle/V-groove and heavy friction with in FIG. 5a, FIG. 5b, FIG. 5c, coincide on rotating in 360 degrees.

Fixing the arms with spring tension touches on ground our required time delay from Pneumatic controlling system shows FIG. 5a, this is absorbed the reaction force from the rotating wheels and entire vehicles weight acting in ground. In this function only all rear wheels in moving directions connecting with FIG. 5. Then the friction is reduced by the FIG. 5a/5b/5c components. Here is hold by aircraft landing gear and bicycle single side stand with extension spring mechanism utilized.

The front wheels absorb the reaction force both wheels in moving directions and the front wheels friction side reaction force reduced by the FIG. 5a/5b/5c. At the end of stage FIG. 5d last reaction force absorbing by the entire FIG. 5a/5b/5c, this same design absorbing the load and to reaction force for suitable size variation only.

When the collision happens as it shows on the FIG. 3^{rd}, and FIG. 5^{th} and the FIG. 6 will work. In this mean it is time nearer to the wheels which is fixed with the rear axis and front axis.

FIGS. (1, 2, 3, 4, 5, 6) are in the process, the FIG. 7 shows the hydraulic/springs tension with the help of FIG. 4 high tension knife cutter by FIG. 2 within a millisecond process is used to stop and hold the rotating wheel of vehicle.

FIG. 7 shows that the time of functioning is on both left side (or) right side upset of the vehicle rectified the FIG. 8. It shows to reduce the vehicle damage and human major Injury; it can be worked for the light vehicles (i.e. Four Wheelers). When the FIG. 7 occurs on the accident the FIG. 8 can react on the parallel of the FIG. 7.

FIG. 9 Illustrates perpendicular to the FIG. 8 and parallel to the motor vehicles axis this is used for heavy-motor vehicles, example for Volvo buses and long and more than multi axle motor vehicles mounted in this type of the vehicles only.

FIG. 1 is below from the chassis in suspension to increase the bottom leaf for the overall vehicles distribution load to observe on fixing the spring to the reaction on the ground. As shown in FIG. 10 to prevent from the vehicles shaking, vibration resolved the kinetic energy and inertia force.

FIG. 11 shows that fixing of acrylic sheet in vehicles. Even the high speed of the vehicles at collide will not be broken. Weightless is also increasing the economic fuel consumption.

The driver seat can only face the travelling direction of road side, others all seated in rotate clock or anticlockwise of 180 degree. If the vehicles stopped suddenly the passengers will not be affected the face and eyes this procedure for back side our main bone supporting in seat and absorbed from vehicles shakes and vibrations, inertia force.

### SUMMARY OF THE INVENTION

| SI. | | PART |
|---|---|---|
| No. | PART NAME | NUMBER |
| 01 | C-Channel | FIG. 1 |
| 02 | Solid roller | FIG. 1a |
| 03 | Hooks | FIG. 1b |
| 04 | Z-shape Stretch from LMV | FIG. 1c |
| 05 | S-shape Stretch from LMV | FIG. 1d |
| 06 | U-Channel | FIG. 2 |
| 07 | Cutter knife | FIG. 2a |
| 08 | Contact and Non contact sensor | FIG. 2b |
| 09 | Connector type 1 | FIG. 3a |
| 10 | Connector big air gap type 2 | FIG. 3h |
| 11 | Connector small air gap type 3 | FIG. 3c |
| 12 | Future irregular shape air gap type 4 | FIG. 3d |
| 13 | Elliptical connector | FIG. 4 |
| 14 | External brake shoes parallel to tire type1 | FIG. 5a |
| 15 | External brake shoes type 2 | FIG. 5b |
| 16 | External brake shoes type 3 | FIG. Sc |
| 17 | External brake shoes special to train | FIG. 5d |
| 18 | External brake holding device | FIG. 5e |
| 19 | Future external brake shoes perpendicular to tire | FIG. 6 |
| 20 | Stabilizer leg downward part | FIG. 7a |
| 21 | Stabilizer leg downward part | FIG. 7b |
| 22 | Stabilizer leg downward part | FIG. 7c |
| 23 | Stabilizer leg downward part | FIG. 7d |
| 24 | Stabilizer leg downward part | FIG. 7e |
| 25 | Stabilizer leg downward part | FIG. 7f |
| 26 | Stabilizer leg upward part | FIG. 8a |
| 27 | Stabilizer leg upward part | FIG. 8b |
| 28 | Stabilizer leg upward part | FIG. 8c |
| 29 | Stabilizer leg upward part | FIG. 8d |
| 30 | Prevent upset device | FIG. 9a |
| 31 | Prevent upset device | FIG. 9b |
| 32 | Prevent upset device | FIG. 9c |
| 33 | Prevent upset device | FIG. 9d |
| 34 | Prevent upset device | FIG. 9e |
| 35 | Special leaf spring | FIG. 10a |
| 36 | Square and ground end spring | FIG. 10b |
| 37 | Unbreakable acrylic Sheet | FIG. 11 |
| 38 | Future two wheeler device | FIG. 12a |
| 39 | Future two wheeler device | FIG. 12b |
| 40 | Multi bended rod two wheeler device . | FIG. 12c |
| 41 | Inner connection type 1 | FIG. 13a |
| 42 | Inner big air gap refer FIG. 1 with 3b | FIG. 13b |
| 43 | Inner small air gap refer FIG. 1 with 3b | FIG. 13c |
| 44 | Mount on road filler | FIG. 14a |
| 45 | Future cycle device | FIG. 14b |
| 46 | Future cycle device refer FIG. 12c | FIG. 14c |
| 47 | Assembled view in four wheeler | FIG. 15 |

### Passive Infrared (PIR) Sensors

In a preferred form of the invention, a sensor system, such as a time delay units and identify human blood cell in future PIR sensors mounted both on the vehicles and human 360 degree from ground clearance same altitude heights the road in front of the vehicle and generate detect information which is controller analyzed per sensor in combination with a range sensing system to warn the driver of hazardous condition, during driving by operating a controlled, and road conditions ahead of the vehicle shake and vibration of vehicles may be collision sensors fixing points very important one.

The preferred form of the invention provides without motor vehicles accident and cooperate in indicating to the driver of a motor vehicle-both road sides fixed the components normal and hazardous road conditions ahead as well as driving variables such as distances to touched the sensors, and other vehicles, the identification, direction of travel and of such other vehicles and the identification of and collision to each other slowly observing human such as barriers, center islands also fixed the components in future, pedestrians, parked cars poles, sharp turns in the road and other conditions. In addition, the human/pedestrians analyzing controller of the vehicle may be operated to sensors and decode coded and/character containing signs or signals generated by Versa pro & FLUIDSIM software a pneumatic control system. This method for future program saved in mini chip, utilized adopter anywhere in vehicles fix and operating possible

The pneumatic controller is operable to analyze sensors and/other forms of delay information generated as the vehicle travels to identify pedestrian ahead of the vehicle and, in certain instances, quantify the collision between the vehicle containing same on the basis of the size of the identified vehicle or sensors and/or by processing received signals. Using such identifying information and comparing it with information on the shapes and sizes of various vehicles such as rear and front axle of all production vehicles and the like and their relative sizes or select dimensions thereof, indications of between the collisions to such other vehicle may be observed and indicated as further codes.

When the closing collision becomes hazardous, select vehicle subsystems may be automatically controlled by the controller as it continues to analyze image signals generated by the sensors. A first subsystem generates a first select sensors or codes which controls an electronically, such as a collision to the vehicles cause it to absorbed by the control indication, such as one or more function during on the time between the multiple axis the external braking system. For example, both side on the road adjacent its path of same altitude from the ground clearance height fixed the dimensions, the second subsystem generates a sensor in the heavy vehicles or buses fall on light vehicles on the ground which control a devices generating means which generates a select in gravitational force observed on the earth and from shaking vibration smoothly this is without major injuries may be minor injuries happen on the difficult situations.

A seventh subsystem comes on the road fast collision and generates one or both vehicles, which are applied to at pneumatic system effect a corrective action such as by pulsing one or both motors vehicles, without upset to apply the brakes of the vehicle to cause it to suddenly back side wheel in moving direction stopped the vehicles. It is necessary to avoid or lessen the effects of an accident. FIG. 5 external breaking systems stops the forward travel of the vehicle and reverses direction reaction force in a controlled manner depending on the relative speeds of the two vehicles, and/or the controlled vehicle between collision and upset the vehicles fallen there between.

A eight subsystem, which may be part of or separate from the seventh subsystem, may generate one which are applied to either effect parallel to the reaction from the earth opposite functioning this components on the road, heavy container with wooden load above 50 ton to 100, fallen of the light vehicles without damages the vehicles and save the driver and passengers. Complete control of the mechanism for the vehicle to avoid vehicles damages and save the driver and invaluable human lives. Either or both the seventh and eighth subsystem may also be operatable to control one or more safety devices by controlling motors vehicles upset and heavy vehicles fallen on the light vehicles. Driver and passenger(s) inside the vehicle are saved by the proposed components.

The fifth, sixth, and/or seventh and eighth subsystems may also be operated to effect or control the operations of additional protection of vehicles, between the vehicle collision, crash and other slippery on the road or damaged road condition fat moving the vehicle may be occur the incident, flag or unconditional of the approaching or approached vehicle or a pedestrian of the approaching hazardous condition in future. Sensors of these subsystems may also be operated to generate and resolve and sensors signals received and used by the approaching or unapproachable vehicle or a roadside device to effort additional sixth subsystem functioning for future analysis, if necessary.

In a modified form of the invention, between the vehicles absorbing system may also include a sensor receiving means to receive signals from other vehicles also fixed there the sensors every minimum space dimensions from start 100 mm to 300 mm. It is assigned by the vehicle size and light or heavy vehicles different length horizontally to face another vehicles, each height from ground clearance same altitude at the side of or within the road for controlling by the sensors.

The systems and methods of this invention preferably employ controlled by sensors analyzing techniques of the types disclosed and defined in such patents of mine as doing and thinking/research scholar, using electronics and existing devices airbag, advanced sensors object/obstacle observed by the camera, image scene etc. . . . . But here all components between the collision motor vehicles after few milliseconds, the system starts functioning all devices and cost wise very low when compared with the airbag, ABS brakes etc.

While the invention is described herein principally in connection with an automobile on a roadway, it may be used in connection with controlling all type of vehicles, including a motor vehicle, a boat, or an aircraft in future flying vehicles.

Accordingly it is a primary object of this invention to provide a new and improved system and method for controlling the operation of a powered vehicle.

Another object is to provide a system and method employing controlled the sensors analysis to control or assist the driver of a motor vehicle in controlling. It is the operation to avoid hazardous conditions such as collisions with other vehicles, stationary objects or pedestrians.

Another object is to provide a controlled system and method for controlling between the collisions of motor vehicles, a motor vehicle to lessen the chances of an accident while being driven by a person.

Another object is to provide a system and method employing a mounted on a vehicle both road side same altitude from ground clearance for colliding both vehicles and the fixed stage road side on permanent functioning to be effected during driving at night and in low light, snowing or fog conditions. This is for future analysis, if necessary.

Another object is to provide a system and method employing a FIG. 9 is fixed in top of the heavy vehicles i.e. Volvo bus, Passengers bus more than 10 tires, vehicles this system minimum one pair to need for vehicles lengthwise varied per quantity only, this is parallel to axis, road surface and perpendicular to the vehicles long chassis, mounted on a moving motor vehicle may be upset on road ninth subsystem automatically for gravitational force ground touched on earth then the spring locked on inner, to save the vehicles and passengers.

Another object is to provide a controlled safety system for a motor vehicle which employs a tenth subsystem and an auxiliary extra suspension system of light to heavy vehicles the leaf spring absorb the vibration on road condition poor and sudden braking for absorb the kinetic force and inertia force, convert into the suspension system must be the bottom of the leaf one side half of the vehicles weights absorbed capacity manufacturing provide the good result. This is for future analysis, if necessary.

### DETAILED DESCRIPTION OF INVENTION

In the motor engine must be with auto gear without damaging the gearbox, from the collision between the motor vehicles accidents FIG. 1 Motor Vehicle Chassis male part System illustrating system is fixed now a day. Heavy vehicles channels are just rotating 180 degree which is possible but the light vehicles more than difficult from the absorb the load provide to the chassis. Multiple designs for just altering the male part is very easy to fix in the chassis. This will be used for light & heavy vehicles, like bus, truck, long vehicles, and Trains, Ships, Submarines, All types of flights, Rocket propulsion and future flying vehicles and without fuel from any height of future free fall flights landing on earth and take OFF position respectively. One of devices and other FIG. 1a is the cylindrical solid roller used for the female part guide the roller for limited displacement length moving in horizontally as per the same materials in chassis, in future composite material is used for reducing weight to the driver of the vehicle of a hazardous road condition ahead and/or to effect controlled braking and steering actions of the vehicle.

a. In FIG. 2 movable components can be used in female part moving between the FIG. 1 guides through the FIG. 1a is the cylindrical solid roller moving up to limited displacement length wise horizontally motor Vehicle both between vehicles and road side fixed device FIG. 13 also collision at any speed and different type of the vehicles. Avoidance System herein of FIG. 1, FIG. 2 and FIG. 2a are the contact and noncontact sensors this is on collision between the vehicles suddenly stopped by the motor engine FIG. 2b and FIG. 2c in future shape of the observe the aerodynamic shape of the FIG. 1 and FIG. 2 in the PIR sensors and pneumatic system attached in the new good design. In this design, attaché the vehicle for female of FIG. 1 front and back up to one meter distance and must leave and right and left of the vehicles between the mirror dimension over all mirror end to another mirror up to end not exceed to the dimension for the reason for collision reduced and tool booth way exactly heavy vehicles width dimensions, beyond not projected the both side mirrors end.

FIG. 3 is to be connected FIG. 1 and FIG. 2 the size of cross section view for octagon for heavy force absorbed long time use in the components and future alternative shape is designed to reduce the damage during the accidents by altering the shape square/round/oval/Rectangle/Polygons/Irregular and size (length, area) FIG. 3a, and FIG. 3b, FIG. 3c, FIG. 3d, FIG. 3e, FIG. 3f, for same purpose for the connecting to FIG. 1 and FIG. 2

FIG. 4 is the length wise variation only closed structure of a FIG. 4. Is the failure condition in future then used the pneumatic system connected with the FIG. 5 structure of aircraft landing gear mechanism utilized in the pneumatic system components controlled by FIG. 5e. FIG. 5f, this is for future analysis, if necessary operations continued will be successful one.

FIG. 5 is creativity of my mind, chariot wheel suddenly stopped by the carpenter ongoing chariot the speed from 5 km/hr up to 10 km/hr without damage chariot and multiple pull force by the human, but the chariot doesn't slip. The same concept utilized in the motor vehicle is an excellent external braking system alternate embodiment of a FIG. 5a, FIG. 5b, FIG. 5c, FIG. 5d, any one of the design manufactures by the same tire materials, with change the any properties for reducing the heat and quickly to allow oneself to be caught the rotating wheel. We provide heavy friction and the each wheel stopped by two piece of chosen material attached with FIG. 5e, FIG. 5f this structure of aircraft landing gear mechanism is utilized in the pneumatic system components, supporting and holding the FIG. 5 without decelerates the motor vehicle wheel, In futures special shape FIG. 5g should be used in All types of trains expect Magnet Levitation trains.

As shown in FIG. 6 is a block diagram for future use, if not necessary operations may be use in extra safety for Motor Vehicle without fallen. This is jointed to the FIG. 5e, uncontrolled the vehicles by the driver without steering-condition recognition of dangerous situations functioning the FIG. 6 is more protection to the motor vehicles if need manufacture by the same tire materials with change the any properties for reduce the heat and quickly lock the rotating wheel.

FIG. 7 illustrates typical mounted in chassis bottom side front and back side near to the axis. We require angle with 90 degrees decrease and increase the angle calculation in the motor vehicles classification of light vehicles and heavy vehicles. The design consisting must have 0.4 pieces with spring tension controlled by the pneumatic system touches on the ground in few milliseconds, functioning in this component the motor vehicle prevent from upset and fallen for operating in the FIG. 5 at the time may be during the session upset and fallen controlled by the FIG. 7 to the earth.

FIG. 8 is-mounted in the light motor vehicle from chassis top side parallel to FIG. 7. This components saved the container, long and heavy vehicles fallen on the light vehicles support on the 4 pieces and avoid the light motor vehicles damages. The driver with passengers is saved and hold the component FIG. 9 by the FIG. 8. Here will be jointed to the FIG. 8a is light motor vehicles are fixed to moving direction and long chassis to parallel.

In another embodiment FIG. 9 Illustrates perpendicular to the FIG. 8 and parallel to the motor vehicles axis this is used for-heavy motor vehicles, example for Volvo buses and long and more than 10 tires motor vehicles mounted in this type of the vehicles only. Heavy motor vehicles are turning in the 90 degree bend on the road while driving fast by the driver. This is the difficult situation for the motor vehicles bending side fallen during the function for the earth gravitational force attracted in the ground with spring tension locked in limited displacement. This observed the kinetic force and the vibration and shaking without touched the heavy motor vehicles body on the ground. So save the heavy motor vehicles from damages and prevent the passengers, driver from major injuries. If the seat belt properly used by the passengers, will not get minor injuries. So if passengers have the seat in the opposite direction of the driver seat to avoid major injuries during the accident. The same methodology is used in train, 50% of peoples seated in moving direction opposite. Now day in metro city new passenger's buses introduced the just few seat only change the cited above directions mounted in the buses.

FIG. 10 is an embodiment of suspension springing system. This is very useful for absorb the vibration and shaking force from all type of the motor vehicles. The heavy vehicles most important part of the leaf spring and axial load on the spring absorb the kinetic force, inertia force the improper road condition. The load is acting on the leaf spring. So the bottom of one spring modified in FIG. 10 then our require angle fixing in the spring type is plain and ground ends or square and ground ends this is suitable for the situation all type of motor vehicles, trucks, and heavy harvester motor vehicles used this type of springs, may be resolved by the FIG. 3 in future use this type of the components.

In an alternate embodiment, FIG. 11 is modified the glass by acrylic sheet throughout the entire automobile motor vehicles front and back and side on the Hazard Collision time protect the human injuries and light weight over all the vehicles weights also reduced by acrylic sheet. Because the density and weight of acrylic sheet material is very low compare to glass. Two wheeler user also have the helmet with front covered transparent glass material to avoid major injuries on his/her face. But the acrylic sheet never damages his/her face but with minor injuries

FIG. 12 is a block diagram of future use analysis for two wheeler to prevent from accidents in the two wheeler, both side mirrors are fixed with the sensors same altitude from the ground clearance and it is throughout the two wheeler in collision time touched area finding out the surrounding. The sensors are at the comparison to FIG. 02 and FIG. 13, must be fixed in center. The sensors and the collision with the motor vehicles and both road sides touched in heavy force automatically stop the two wheeler driver with back seated also avoid from accidents. Additional to the FIG. 12a and FIG. 12b fixed in the two wheeler Total registered vehicles for 2012 in India=15,94,90,578. Cars and 4-wheeled light vehicles=38,338,015. Motorized 2- and 3-wheelers=11, 54,19,175. Heavy trucks=40, 56,885, Buses=16,76,503 this data is referred by the World Health Organization the report.

In India above 0.11 crores two wheelers and four wheelers accident are registered. Compare to the World wide during the motor vehicles accidents collision by the 2 and 3 wheeler 34% and cyclist just 4%. If we fix the sensor 3 wheeler auto with same altitude from the ground clearance and attached the all types of components for protecting driver and the middle class passenger without damages by the components.

A particularly attractive embodiment of the decision FIG. 13 of cross sectional view of the inner main important part of FIG. 3 connecting with FIG. 1 and FIG. 2 this will be complicated the procedure with the camera help hook refer to the FIG. 13a. is this function in the FIG. 2 through the model of tube less tyre puncher work method hole the FIG. 3 and pull heavy force to grasp FIG. 2. is separately multi movable parts. This procedure, for finally completed with movable components without light source may be torch light in use of without camera hook utilized holding and to grasp is possible and hook insert make the temporary hole in FIG. 2 create the end of the work covered/closed the holes. In FIG. 13 is a control structures in the Motor Vehicle both road side fixed just one time up to future in same railway track fixed then maintenance only fixed one time same concept up to rotate the earth and last human lives in the World. These devices are to prevent motor vehicle from accident possible by the cited above all the innovative components.

FIG. 14 is a future use and analysis for cyclist, prevent from motor vehicles accidents. In cyclist both having mirror fixing the sensors and the device compare to the FIG. 2 and FIG. 13 on the road side centre fixed the sensors and the collision with the motor vehicles and both road sides touched in heavy force automatic suddenly stopped the cycle driver with back seated occupier also avoid from accidents. Additional to the FIG. 14a*and FIG. 14b are fixed in two wheeler. The World health Organization by the cyclist 4% motor vehicles accidents to avoid the fatalities must fixed the FIG. 14a and FIG. 14b each cycle mandatory.

FIG. 15 is final assembled view of the new innovative of all the automobile components above mentioned FIG. 1 to FIG. 14. For this assembling in a model car/van this attached the FIG. 2 components for already existing device like airbag and bumper front and back both front two seat airbags and 4 seats airbags cost wise compared for light vehicles 4 persons with driver travelled vehicles INR=just 50,000.00 only for ⅔-time bumper change cost. These devices with high protection and very low cost without damages vehicles and up to individual human or pedestrian saved by the components. May be mass production, the components reduces cost wise in future and materials are very cheap cost and centre same altitude from the ground clearance and the same height from the walking child. Same altitude from the his/her shirt fixing based on the height of the persons, sensors between collision with in a few millisecond human blood circulation only detects by the pneumatic controlling system scene activated to prevent from individual pedestrian from the motor vehicles accidents. It is the best suitable method

Without obstructions approval by the Indian and World Wide all the Government mandatory must fixed the devices for same number plate by Road Transport Authority provide to the approve to the front, rear, or to either side of the vehicle and road side in all types of the road like High way and single way multi lane bye pass just left and right and centre only fixing in the FIG. 13 in future without motor vehicles accident. We are protected and 34.2% fatalities by the motor vehicles accidents death in every day, save the invaluable human live and without damages vehicles and the save the vehicles damages cost, medical causality medicine cost, Insurance claim for life and non-life to save the approval country, save the police and court time, ambulance approximately one day printable money by the country 8% to 12% losses and, the money transaction from there in the field and the very big job opportunity and growth the national income.

### BRIEF DESCRIPTION OF DRAWINGS

The various automobile components and sensors, pneumatic controlling systems elements used to carry out the invention described herein are illustrated in the form of block diagrams, flow charts, new design car structures. The preferred embodiment is illustrated in the refer figures.

FIG. 1 is a block diagram of the overall Motor Vehicle Chassis male part System illustrating system is fixed one of devices and FIG. 1a is the cylindrical solid roller as per the same materials in chassis. In future composite material may be used to reduce weight.

FIG. 2 is a block diagram of movable components used in female part guide through the FIG. 1a is the cylindrical solid roller moving up to limited displacement. Vehicle Hazard Avoidance System herein of FIG. 1, FIG. 2a is the contact and noncontact sensors this is on collision between the vehicles suddenly stopped by the motor engine. In future shape of the absorb the aerodynamic and eye blinking type for good design.

FIG. 3 is a block diagram of connected FIG. 1 and FIG. 2 the cross section view for hexagon/octagon to heavy force observed long time use in the components and future alternative shape FIG. 3a, and FIG. 3b, FIG. 3c, FIG. 3d for same purpose in the connecting to FIG. 1 and FIG. 2.

FIG. 4 is a block diagram of length wise variation only closed structure of a FIG. 4. This is failure condition in future then used the pneumatic system controlled by FIG. 5e, this is for future analysis, if necessary operations.

FIG. 5 is a block diagram of motor vehicle is an excellent external braking system alternate embodiment of a FIG. 5a, FIG. 5b, FIG. 5c, FIG. 5d useful in the system connected to the of FIG. 5e.

FIG. 6 is a block diagram of future use analysis, if not necessary-operations, may be use in extra safety for Motor Vehicle without fallen this is jointed to the FIG. 5e.

FIG. 7 is a block diagram of illustrates typical in chassis bottom side. We require-angle for vehicles designing decrease and increase the angle useful in the Motor Vehicle, prevent from upset and fallen to the earth.

FIG. 8 is a block diagram which illustrates the typical mounted in the Motor Vehicle from chassis top side to parallel FIG. 7 up to the FIG. 9 hold and balancing the component.

FIG. 9 a block diagram of illustrates perpendicular to the FIG. 8 used Motor Vehicle for heavy vehicles and buses only.

FIG. 10 a block diagram of suspension springing system useful in implementing and observe the vibration and shaking from motor vehicles.

FIG. 11 a block diagram of modified the glass instead acrylic sheet front and back and side on the Hazard Collision time, protect the human injuries and light weight over all the vehicles weights also reduced by acrylic sheet.

FIG. 12 a block diagram of future use analysis for two wheeler prevent from motor vehicles accidents in the two wheeler both mirror fixing the sensors and the device centre fixed the sensors and the collision with the motor vehicles and both road sides touched in heavy force automatic suddenly stopped the two wheeler driver with back seated occupier also avoid from accidents. Additional to the FIG. 12a and FIG. 12b fixed in the two wheeler.

FIG. 13 a block diagram of cross sectional view of the inner main important part of FIG. 3 serials connecting with FIG. 1 and FIG. 2 this will be complicated one refer to the procedure in FIG. 13 control structures in the Motor Vehicle.

FIG. 14 a block diagram of future-use analysis for cyclist prevent from motor vehicles accidents in cyclist both mirror fixing the sensors and the device centre fixed the sensors and the collision with the motor vehicles and both road sides touched in heavy force automatic suddenly stopped the cycle driver with back seated occupier also avoid from accidents. Additional to the FIG. 14a and FIG. 14b fixed in the two wheeler.

FIG. 15 is block diagram of the assembled view of the new innovative all the automobile components above mentioned FIG. 1 to FIG. 13 assembling in a model car/van this attached the FIG. 2 components centre same altitude from the ground clearance and the same height from the walk start child may be his/her head cap around fixing IR/PIR sensors human blood circulation only and other pedestrian same altitude from the his/her shirt fixing the sensors between collision with in a few millisecond human blood circulation only detects by the pneumatic scene activated for prevent from individual pedestrian with motor vehicles accidents.

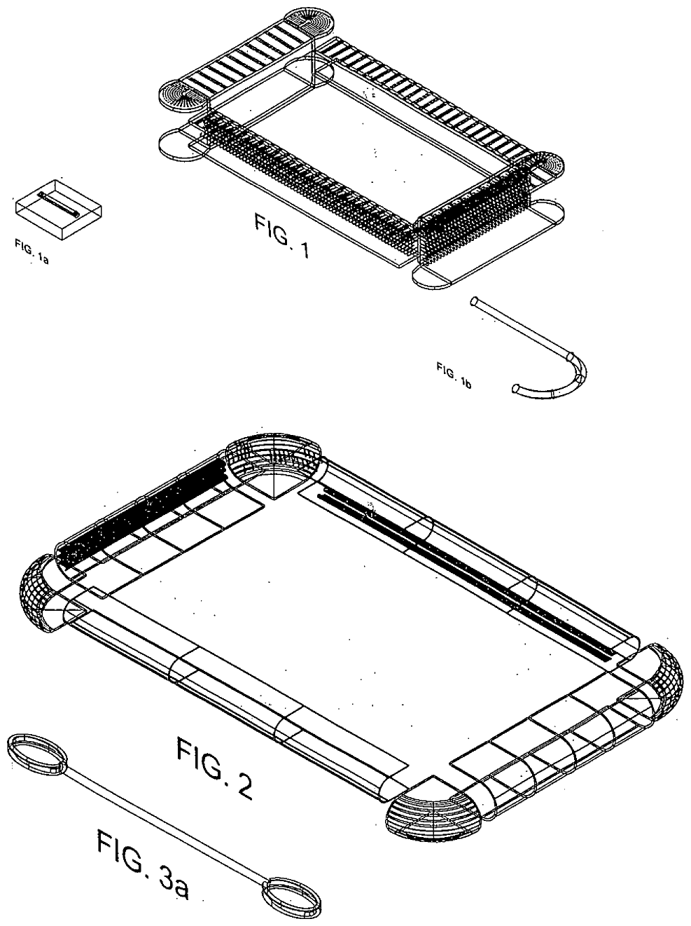

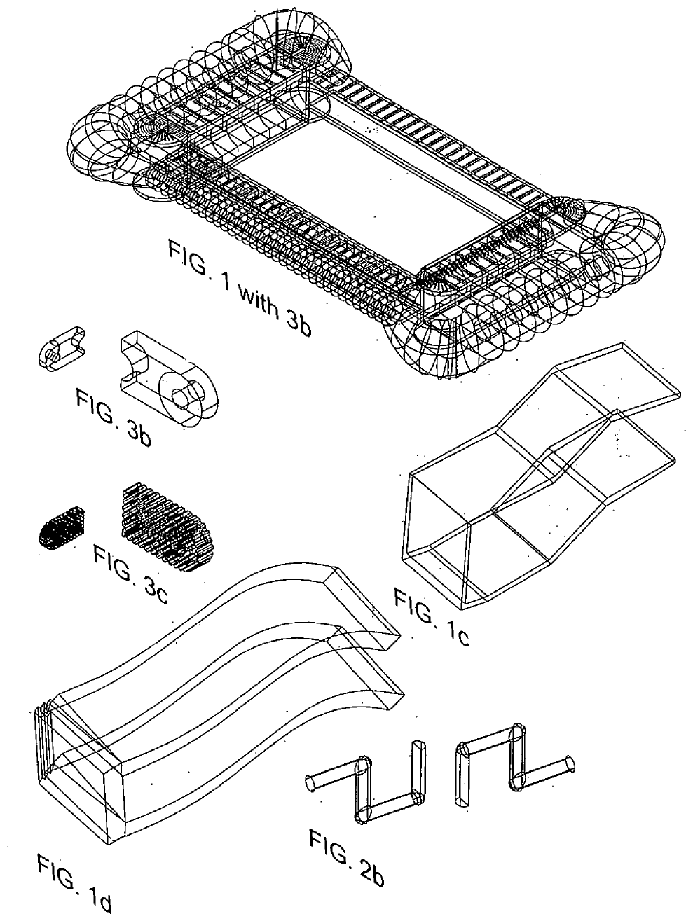

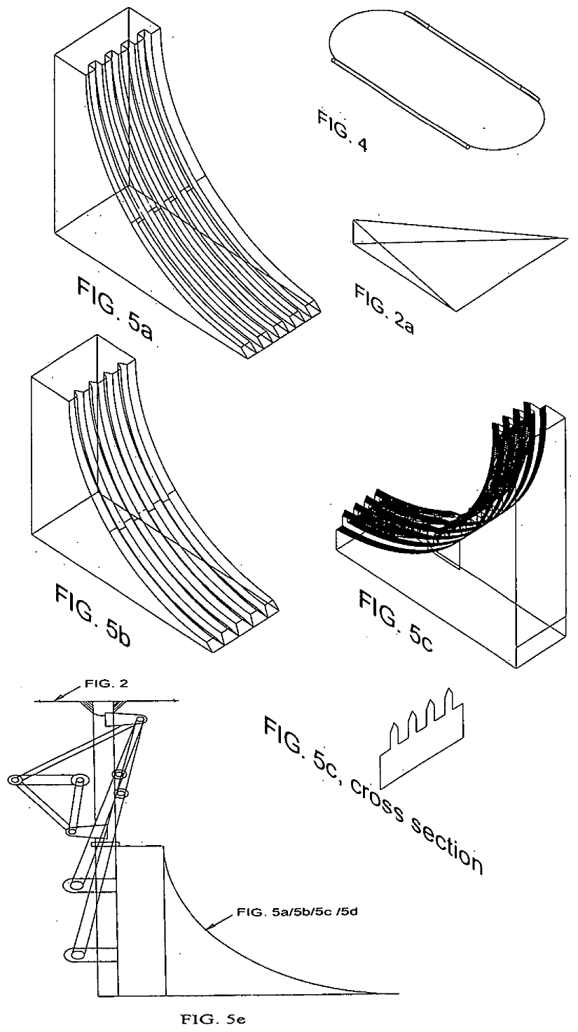

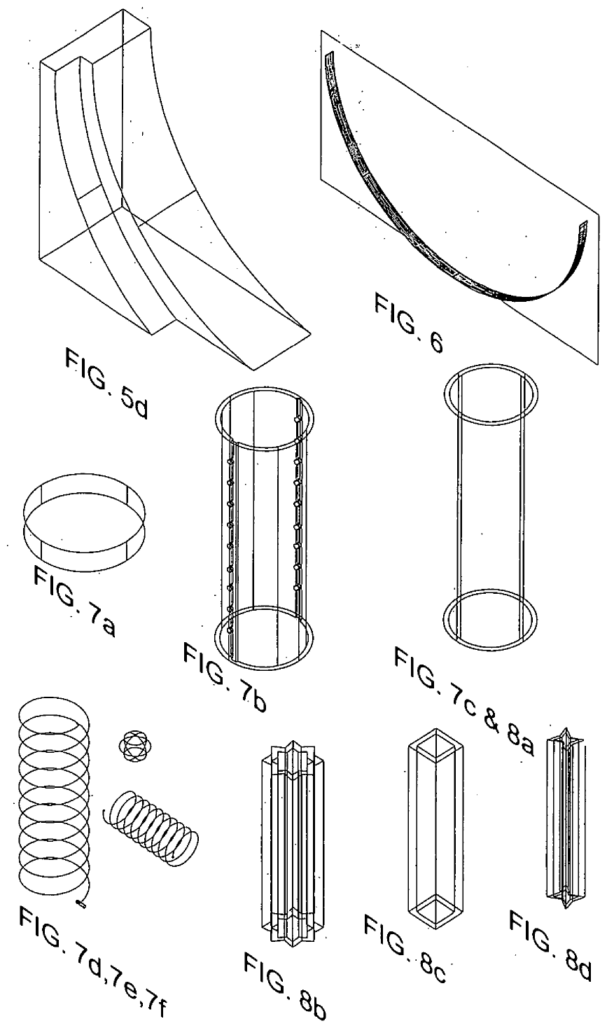

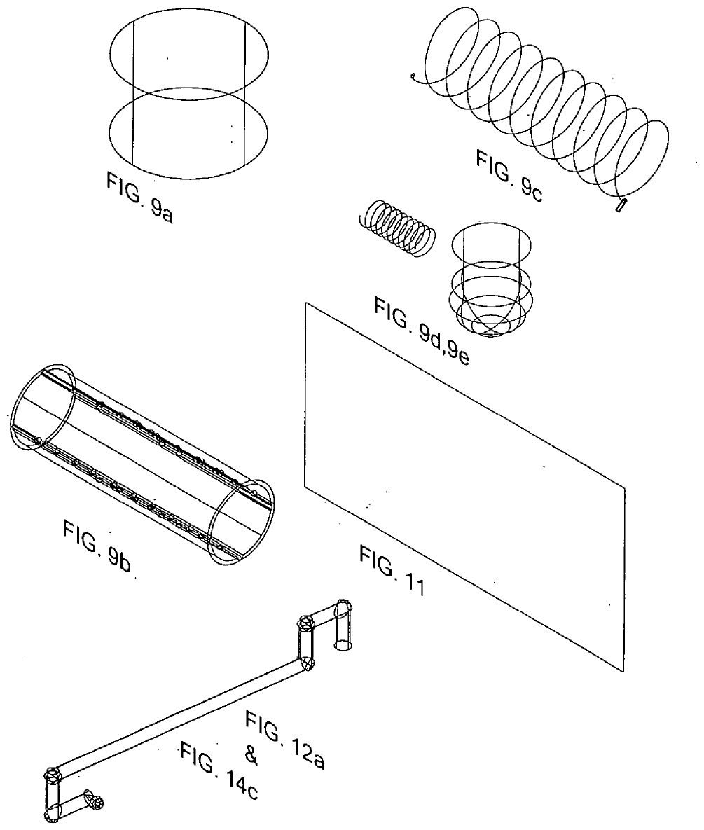

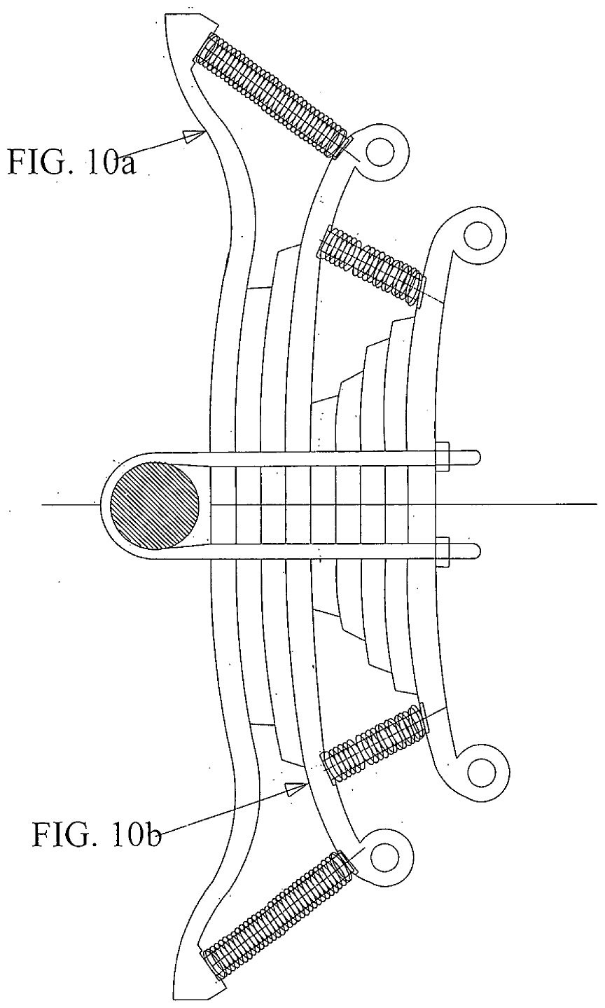

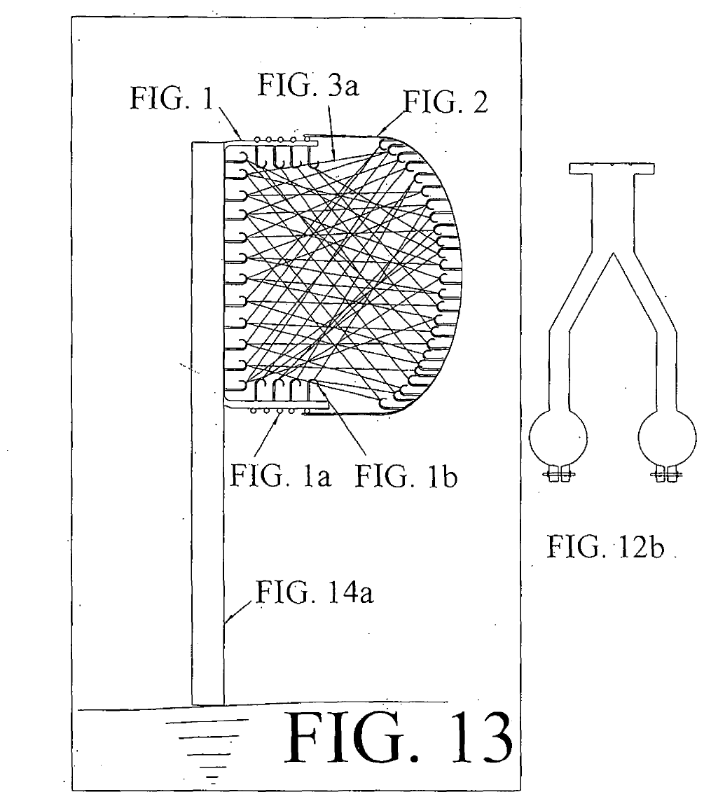

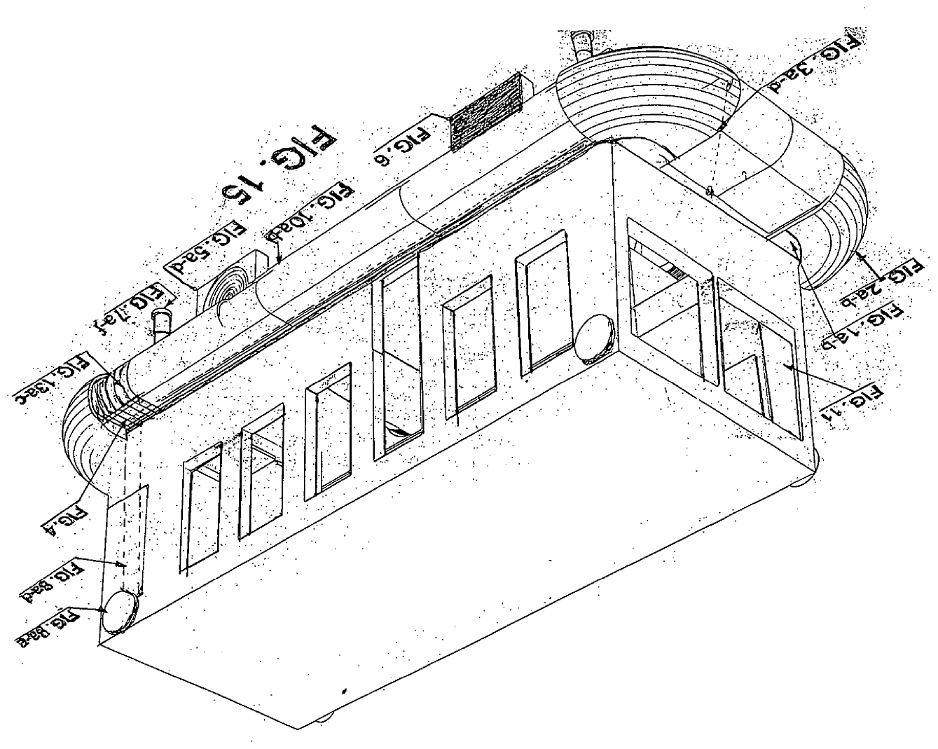

1. An apparatus wherein:
Usually “C” channels are tilted inward in every vehicle; In this invention the said channels have to revert by 180-degree (outward) this will be applicable only heavy vehicles, like bus, truck, long vehicles, and steam boats, Trains, Ships, Submarines, All types of flights, Rocket propulsion, future flying vehicles and without fuel for land only and tire from any height of future free fall flights landing on earth, like light motor vehicles need to remove bumpers which is fitted in front and rear side according to the length and width the “C” channels have connect with chassis which is fitted above/below the axle;
The shape in heavy and long vehicles from existing “C” channel, alter to visible straight or downward to our require angle as well as light motor vehicles from the chassis/axle to above/upward “S” and “Z” shapes below plastic region stretch upward to our require directions;
The size of the “C” channel and design are slightly higher than the usual size in front and rear side, whereas left and right side “C” shapes channel and design having slightly smaller than the previously said sizes beyond not projected the both side mirrors end;
This said “C” channel collide at exact portion fix in steam boats and Ships, Submarines, front and rear side, whereas left and right side “C” shapes special channel and design are having slightly smaller than the previously said sizes;
The size of the “C” channel and design turn to earth for flights in future without fuel for landing only and tires take off flights free fall by gravitational on earth; Here will be fixed to bottom facing on particular touched portion there will be coincide “U” shape movable channel absorb reaction forces;
The rollers are fitted outer surface of “C” channels, there for only top & bottom through keyway said roller with clearance dimensions; Which do require a separate guide way to avoid slipping; This has to be bended in order to provide stable motion of the said roller also which is reinforced with help of elastic material to absorb shock and vibration, caused due to the collision;
The said roller is fixed on the key way top of the portion with/without holding by axis, but must be the bottom of the portions with axis holding and guide rotating said in the “U” channels; and
The said “C” channels entire inner surface is mounted by hooks by the method of mould/rivet/welded joint throughout every inches.

2. The apparatus of claim 1, wherein the Light Motor Vehicles contain slightly upward than the normal whose angle may be vary from 10:degree to 80-degree above; The angle said to light motor vehicle is to be faced may slightly downwards for heavy vehicles.

3. The apparatus of claim 2, wherein “C” channel coincides with help of said roller movable up to absorb the kinetic energy; The height of the “U” should have the same height from the ground clearance; Said “U” shaped channel thickness from 0.5 mm to above and made by stainless steel/Tungsten/ceramic and any composite materials in futures shape of the absorb the aerodynamic and eye blinking type for good design.

4. The apparatus of claim 1, wherein:
linked using cbndom Nirodh rubber material elastic tensions at collide compressive design, altering the cross sectional area of shapes with air gaps between hanged and holding by hooks;
linked using train damper deform material/cork rubber material design altering the cross sectional area of shapes with special types of any irregular air gaps for absorb kinetic energy by the said materials; directly fixed at anywhere our require fuse/creativities of contact and non contact sensors are from 0.5 mm to above copper wire twisted to our require bending 90-degree then bended portion again 90-degree and again outward again 90-degree, said sensors have two pieces through the air gap linked serial up to starting key connection, must after collide key OFF by driver/manual used for said sensors, but said fuse automatically OFF;
linked using eye blinking shape sensors, said sensors fixed on continuously; The said sensors side of tires from ground clearance 2″ height fix controlled by the program stored chips connecting with GPS to main server, operated by the system coding “C-Program/Mat lab software/Pneumatic Logic Controlling by coding in futures units activated by said sensors; This will be released in 2025 onwards and above;
eye blinking shape sensors connected with the waves, controlled by CNC, components with tire vehicles, but without tires vehicles; This will be released in 2030 onwards and above;
Only four said sensors will stop the world entire vehicles; It will be released in 2035 onwards and above.

5. The apparatus of claim 4, wherein the heights said to ground clearance during collision the heavy forced tighten cut off with the help of “U” Shape sheets with knife edge, due to the said process external breaking system activated with help of contact and non-contact sensors/fuse fixed.

6. The apparatus of claim 3, wherein the external breaking system are to stop the rotating wheel immediate, in rear side first and front side after few millisecond; This breaking system in future flying cars and flights and special shape should be used in all types of trains except Magnet Levitation train; Air craft landing gear mechanism is adopted to stop the rotating wheels, no need for without flying flights for said systems;
the brakes ground touched the face portion tires button without any (zig-zag) design planning, but must will be square/rectangle/v-groove and heavy friction with in FIG. 5a, FIG. 5b, FIG. 5c, and expect FIG. 5d coincide on rotating in 360 degrees;
the ground touched portion will be single step flat surface of the curvature adopting aircraft landing gear mechanism for train wheels stopped.

7. The apparatus of claim 6, wherein the shape is quadrant, derived from right angle triangle, a curved portion is removed according to the radius of curvature of the wheel; The said portion should coincide the rotating wheels, the base bottom side of the portion should touch the road/earth, and both are coincide side and bottom side very fast gel thin film cover and filled in inner area; The male both two sides swelling and tight grip utilized above said gel stopping the rotating wheels.

8. The apparatus of claim 7, wherein the shape is operated with the help of Programming Logic control to avoid upset of the vehicles during collision; This is fitted under the front axle or nearer to the chassis; This function, through both side key way with nearer holes special design head with spring tension required and shock absorber rear side two absorber after few milliseconds.

9. The apparatus of claim 8, wherein on the chassis in Light Motor Vehicles frames of all comers through box frame high strength pipe or irregular and star shaped joints interconnected together; It is preventing from heavy load container and long vehicles fallen upon LMV to save the driver and passengers; Top side is parallel to the axis and jointed with said joint and which has a hollow pipe only applicable for buses and heavy/long vehicles.

10. The apparatus of claim 9, wherein the components will be fitted only to LMVs; Where as in other vehicles parallel to the axle, due to the gravitational force which hits the ground with the help of the reinforce spring; This may happen to the vehicle under turning at higher speed.

11. The apparatus of claim 1, wherein during the mishap, presently available glass should be replaced with an acrylic sheet (transparent) which prevents major injuries and reduction the vehicles weight.

12. The apparatus of claim 1, wherein all the components 3-wheeler like Auto rickshaw; It is fitted to the vehicles to avoid from collision; The passengers and drivers are saved from the auto collisions.

13. The apparatus of claim 1, wherein this shape entirely different from special type fixed in rear and front suspensions connected the component with IR/PIR sensors for two wheelers; Above said “U” channel in centre coincide through the said sensors; A multi bended rod is fitted with the kicker of the two wheelers to prevent starting of the engine when the side stand is in action; In kicker less bikes an alert in red color bulb will be glowed at the dash panel and LMV also without close door alert in said bulb by serial electric connection; The said facility will also be incorporated in the conventional.

14. The apparatus of claim 13, wherein finally to avoid an accident of vehicles with the human when they are walking or crossing the road; The said height which will be same as that of sensors fitted around the outfit of the human; The sensors used in this category will be IR & PIR sensors which is having a size of from 0.5 mm to and above working under the range of blood pressure; Thus actuates said sensors fixed single or multiple rows and columns which will enable to stop the vehicle in order to prevent from individual human accident.

15. The apparatus of claim 4, wherein the variation of the size length, area in FIGS. 3 and 5 change in color or addition of any others composite materials may not be acclaimed by another in any future as per the PCT patent regulations, because applicant holds the authority in establishing the fact that the usage of the FIG. 3 a,b,c,d & FIG. 5 a,b,c,d from the minimum dimension of diagonal referred and above up to maximum possible is sold;
Illegal production can be reduced by punching serial number for each component must be manufacturer as per the International standards, all saved to the main server, easy to identify;
FIG. 5 plays an important role for the excellent external braking system and the groove way of cross sectional area must design and planning only full/half square or small rectangle long side dimensions parallel to motor vehicles axis, and combined the V-groove depth in perpendicular to the axis of the inner side;
above mention in background of invention from the title was registered on 14 Dec. 2004 through letter from Singapore Post at President office in India, Delhi; From the date any small changes in the design by any other person in throughout the world any patent office filing without consider maybe approved by the patent provided to him/her/them, will be cancelled by the PCT act regulation and Intellectual property crime;
Up to rotate the earth and human living in the world this FIG. 3 & FIG. 5 serials designs having authority only by me.
